(19) United States
(12) Patent Application Publication
(10) Pub. No.: US 2017/0191521 A1
(43) Pub. Date: Jul. 6, 2017

(54) Flexure Mechanisms

(71) Applicant: Gregory R. Hopkins, Logan, UT (US)

(72) Inventor: Gregory R. Hopkins, Logan, UT (US)

(73) Assignee: Utah State University Research Foundation, Logan, UT (US)

(21) Appl. No.: 15/467,996

(22) Filed: Mar. 23, 2017

Related U.S. Application Data
(63) Continuation-in-part of application No. 15/340,356, filed on Nov. 1, 2016.
Application No. 15/340,356 is a continuation of application No. 14/493,545, filed on Sep. 23, 2014, now Pat. No. 9,513,168.

(51) Int. Cl. F16C 11/12

(52) U.S. Cl. CPC F16C 11/12; F16C 2204/20; F16C 2204/66; F16C 2220/60; F16C 2226/40

(57) ABSTRACT

A flexure mechanism may be constructed by joining a first, second, and third material together, wherein the first and second materials are non-flexure materials and the third material is a flexure material that does not have a flexure motion-defining feature. Then, after the joining step, forming a flexure-motion defining feature into the third material. Each of the components of flexure mechanism may first be machined individually and the components may then be joined or assembled in any order. Significant tolerance stack-up may occur during the individual machining operations and joining assembly of the individual components. However, these tolerance issues, miss-alignments or other flaws in the overall assembly may be eliminated in the forming of the flexure-motion defining features as part of flexure mechanism.

### RELATED APPLICATIONS

This is a continuation-in-part application of U.S. Non-Provisional application Ser. No. 15/340,356, filed Nov. 1, 2016, which is a continuation application of U.S. Non-Provisional application Ser. No. 14/493,545, now U.S. Pat. No. 9,513,168, filed Sep. 23, 2014, both of which were invented by Kendall B. Johnson and Gregory R. Hopkins and entitled “LINEAR-MOTION STAGE.” Each of the above applications are incorporated herein by reference in their entirety and are referred to herein as the “Parent Disclosures.”

### TECHNICAL FIELD

The present disclosure relates to flexures, more particularly, to novel systems and methods for making flexures

### BACKGROUND

Motion-generating devices are used as linear stages, rotational stages, or other similar mechanisms where one portion of the mechanism moves relative to another portion of the mechanism. Flexures may be used in place of hinges, bearings, slides, etc. as a means for providing the relative motion in a motion-generating apparatus. U.S. Pat. Nos. 5,620,169, 2,947,067, 4,499,778, and 4,655,096 illustrate and describe various flexures and their methods for manufacturing.

### SUMMARY

A flexure mechanism can provide higher motion precision, have less weight, not wear out, simplify manufacturing, and reduce parts count as compared to hinges, bearings, slides, etc. Typically, a flexure is manufactured from a spring-like material as a separate part and then added to a larger assembly of parts. The flexure allows motion between one or more fixed parts and a moving part. Alternatively, a flexure may be machined as part of a larger a monolithic structure that is entirely made of the flexure or spring-like material.

Manufacturing a motion-generating apparatus with flexures as an assembly of parts can have some disadvantages. For example, in an optical system, each component must be positioned and aligned. Specific displacements and angles between elements must typically be aligned as precisely as the requirements of the system itself. Various alignment mechanisms are used to assure alignment of the various components.

The accuracy to which elements are initially positioned greatly influences the quality or precision of the system. Potential position errors may be induced in an assembly of parts during assembly, alignment, adjustment, calibration, or operation of the components. The alignment process itself is meticulous as each joint that is released or decoupled from other components in order to move a component may miss-align in more than one degree of freedom. Thus, the alignment process is time consuming.

Additionally, individual parts are machined or manufactured with their respective variation and tolerances. Even the manufacturing of a single part requiring multiple machine set-ups or operations can create tolerance stack-up. Tolerance stack-up can induce parasitic motion in a flexure or unpredictable velocity in the moving portion of a motion-generating apparatus.

When a flexure is added to a flexure mechanism as part of an assembly of parts, making the assembly function within its motion tolerance can be complex. The forming time, number of parts, number of required operations, positional tolerance stacking, localized forming defects, assembly variations, and resulting alignment requirements increase both the complexity of the system and the number of dimensional and material variations. The added forming, assembly and alignment requirements increases a flexure's deviation from the desired motion vector.

Additionally, forming one or more flexures as part of a larger, single-material, monolithic structure can also have some disadvantages. For example, the entire structure must be made of a spring-like material such as spring steel, beryllium copper, or titanium, which may or may not be suitable as the overall device or can be cost prohibitive. Similarly, machining a precision, motion-generating apparatus such as a linear-motion stage from a solid block of spring-like material can be time consuming and cost prohibitive.

The inventor of the present disclosure has identified a method for manufacturing one or more flexures into a motion-generating apparatus. The present disclosure in aspects and embodiments addresses these various needs and problems.

A monolithic-like structure may be constructed from initially discontinuous or distinct segments of material that are joined prior to forming flexure-motion defining features or flexures embedded in the structure. In embodiments, a fusion or bonding process permanently, or semi-permanently, joins the non-flexure to the flexure material from distinct components into a monolithic-like single structure. The fusion or bonding process eliminates joints, which in turn prevents inadvertent miss-alignment of flexures due to shock, vibration, or thermal expansion. In addition, manufacturing a monolithic-like single structure reduces thermal gradients across the entire structure and increases stiffness. Similarly, manufacturing a monolithic-like single structure removes assembly components which can have short functional lifespans, reduces or eliminate cumulative tolerance variations from component manufacturing and the assembly of an assembly of parts, and provides a structure in which movement defining flexures are practical to form in a single machining operation.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1A illustrates a stand-alone beam flexure;

FIG. 1B illustrates a stand-alone cross flexure;

FIG. 1C illustrates a stand-alone planar-notch flexure;

FIG. 1D illustrates a stand-alone spherical-notch flexure;

FIGS. 2A, 2B, and 2C illustrate first, second, and third materials manufactured first into a monolithic-like structure and then a flexure mechanism.

FIGS. 3A, 3B, and 3C illustrate first, second, and third materials manufactured first into an assembly of parts and then a flexure mechanism.

FIGS. 4A, 4B, 4C, 4D, and 4E illustrate first, second, and third materials manufactured first into a monolithic-like structure and then a flexure mechanism.

FIGS. 5A and 5B illustrate a monolithic-like, dual-opposing blade structure and a dual-opposing blade, fine-positioning linear stage, respectively;

FIGS. 6A and 6B illustrate a monolithic-like, block-blade structure and a block-blade, fine-positioning linear stage, respectively;

FIGS. 7A and 7B illustrate a monolithic-like structure and planar motion stage, respectively;

FIGS. 8A and 8B illustrate a monolithic-like structure and a linear-motion stage, respectively;

FIGS. 9A and 9B illustrate a monolithic-like structure and an angularly and radially symmetrical three-arm linear-motion stage with block-blade flexures;

FIGS. 10A and 10B illustrate a monolithic-like structure and an angularly and radially symmetrical three-arm linear-motion stage with blade flexures;

FIGS. 11A and FIG. 11B illustrate a monolithic-like structure and an angularly and radially symmetrical four-arm linear-motion stage with block-blade flexures, respectively;

FIGS. 12A and FIG. 12B illustrates a monolithic-like structure and an angularly and radially symmetrical four-arm linear-motion stage with blade flexures; and

FIGS. 13A and 13B illustrate a monolithic-like structure and a two-axis optical mount with two sets of flexures.

### DETAILED DESCRIPTION

The present disclosure covers apparatuses and associated methods for creating a flexure mechanism. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional”, “optionally”, or “or” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

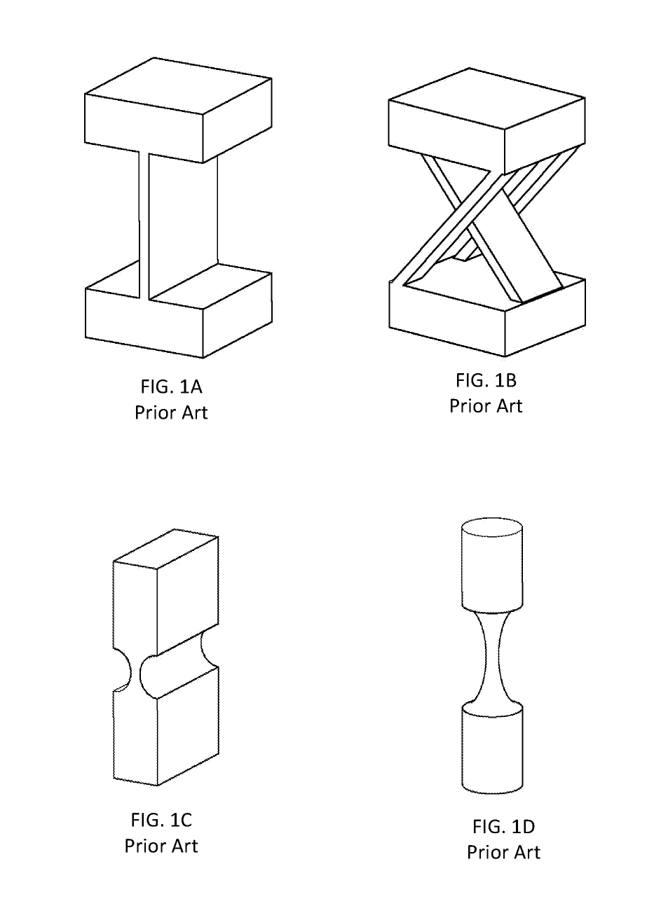

FIGS. 1A-1D illustrate various stand-alone flexures. FIG. 1A illustrates a beam flexure, FIG. 1B illustrates a cross flexure, FIG. 1C illustrates a planar-notch flexure, and FIG. 1D illustrates a spherical-notch flexure. Typical flexure mechanisms may comprise multiple flexures, for example, those shown in FIGS. 1A-1D, manufactured as an assembly of parts. Some disadvantages of using a flexure within an assembly of parts are described above.

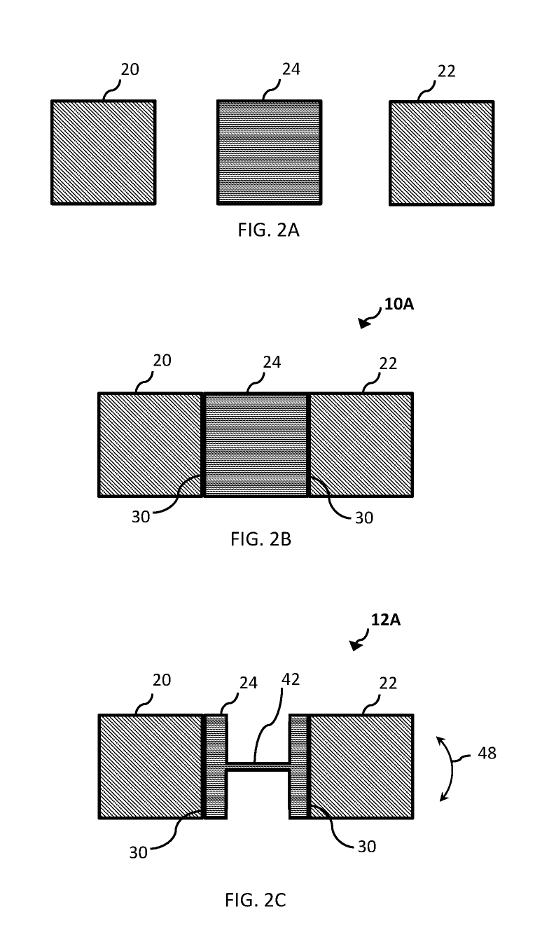

FIG. 2A illustrates a first, second, and third material, labeled 20, 22, and 24, respectively. In embodiments, first material 20 and second material 22 are made of a non-flexure or a non-elastic material. In this disclosure, non-elastic and non-flexure may be used interchangeably. A non-flexure material may be, for example, metals like aluminum or a high-carbon steel that experience stress fatigue. Non-flexure materials are generally non-elastic materials that become plastically deformed when a deforming force is applied. First material 20 and second material 22 may or may not be the same material and may be part of a larger device or apparatus that is not shown. In FIG. 2A, first material 20 and second material 22 are the same material.

FIG. 2A also illustrates third material 24. Third material 24 is an elastic or flexure material. In this disclosure, elastic and flexure-like may be used interchangeably. In this disclosure, elastic, flexure-like, or flexure material terms may be used interchangeably. An elastic material has the ability to resist a deforming force and return to its original size and shape when the force is removed. Flexure materials may be spring steel, beryllium copper, or titanium.

FIG. 2B illustrates third material 24 joined between first material 20 and second material 22. In embodiments, the materials may be joined such that they are fused, brazed, welded, etc. to form a fused, brazed, or welded interface 50 between first material 20 and third material 24 as well as between second material 22 and third material 24. In an alternative embodiment, first material 20 and second material 22 may be additively manufactured or added to third material 24. When joined or otherwise combined as shown in FIG. 2B, the combination of the materials 20, 22, and 24 become a composite, monolithic-like structure 10A.

The manufacture of composites, additive manufacturing methods, forging, diffusion bonding, and metal welding are examples of processes where the resulting union of raw materials or components may be considered monolithic like, or no longer an assembly of parts. In embodiments, for example, in the fused, brazed, or welded interface 50, there is no longer a clear boundary between the original components or where a joint could potentially move. A monolithic-like structure 10A can be advantageous because it eliminates joints where unintended motion could otherwise occur due to joints sticking or slipping during the lifespan of a flexure mechansim. Typically, the union of materials should be designed to function within the environmental conditions experienced during the mechanism's lifecycle.

FIG. 2C illustrates a flexure mechanism 12A that has a flexure-motion defining feature 42 machined into the third material 24 such it becomes a flexure 40. In this embodiment, second material 22 may move relative to first material 20 as shown by the movement indicators 48. In this illustrated embodiment, flexure 40 is a beam flexure. Other flexures may be formed. For example, a cross, planar-notch, or spherical-notch flexure may also be formed in third material 24 depending on the type of relative motion desired between first material 20 and second material 22.

Flexure-motion defining features, such as flexure-motion defining feature 42 described and illustrated throughout this disclosure, may be formed in various manners. In embodiments, a flexure-motion defining feature may be formed by selectively removing material from the third material 24 by use of a wire or sinker electrical-discharge machine. In other embodiments, a flexure-motion defining feature may be formed by cutting, sanding, mechanical milling, electro-chemical milling, chemical milling, water-jet cutting, fluid-jet polishing, etc. The processes of wire or sinker electrical-discharge, electro-chemical milling, chemical milling, water-jet cutting, or fluid-jet polishing may be used to minimize localized deformation or residual stress in the flexure-motion defining feature.

The order of operations of the assembly of monolithic-like structure 10A to flexure mechanism 12A is significant. In this embodiment, as in other embodiments, the flexure-motion defining feature 42 is formed or machined into the third material 24 after that material has been joined to first material 20 and second material 24. In this embodiment, the joining may have been performed through fusion, brazing, or welding processes that expose the materials 20, 22, and 24 to extreme heat. Had flexure-motion defining feature 42 been formed into third material 24 prior to the joining process, the relatively delicate flexure-motion defining feature 42 could have been damaged by the extreme heat of the forming process, reducing the life or performance of the flexure-motion defining feature 42 in flexure mechanism 12A.

In addition to the above, depending on the joining process use, forming the flexure-motion defining feature 42 could not be done prior to joining because the flexure-motion defining feature 42 would be damaged in the joining process. For example, in the case of forging bulk plate or billet materials, it may not be possible to form the flexure-motion defining feature 42 prior to the first, second, or third material components 20, 22, or 24 being joined due to the high stresses being used to plastically deform components in the bending and joint fusion process.

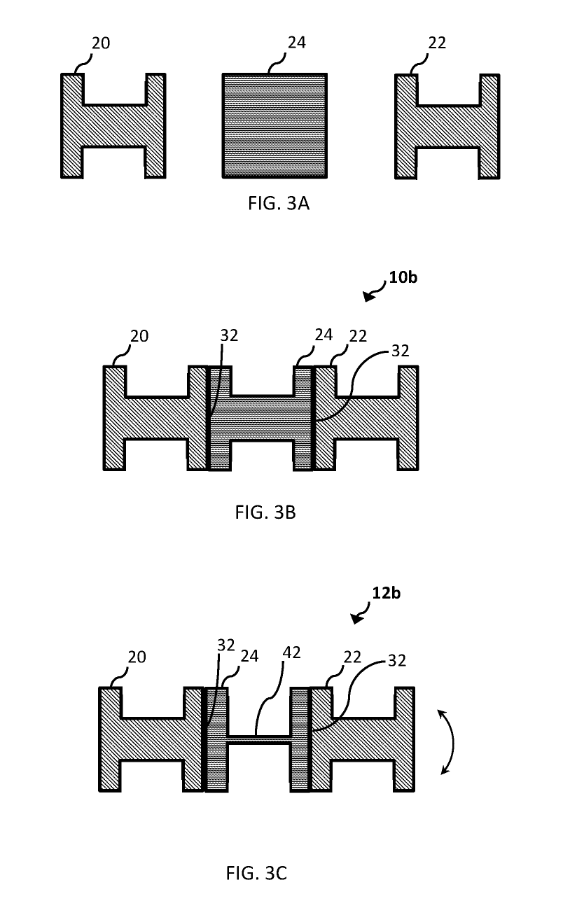

FIGS. 3A-3C illustrate another embodiment of a first material 20 and second material 22 joined to a third material 24 by being glued, bolted, or otherwise fastened together with fasteners (not shown) to form an assembly of parts 14. In FIG. 3B the three materials 20, 22, and 24 are joined with a glued interface 52. The assembly of parts 14 is assembled before a flexure-motion defining feature 42 is machined into the third material 24 (as shown in FIG. 3C).

A “monolithic-like” structure cannot be disassembled without being destroyed or severely damaged. By contrast, an “assembly of parts” can be disassembled without adversely affecting the constituent components. However, if a flexure-motion defining feature is machined into a flexure material that is part of an assembly of parts and the assembly of parts is disassembled, the flexure alignment features inherent in machining the flexure-motion feature post assembly may be lost. Upon disassembly, flexure alignment features may be lost to the extent that flexure components assume a new position relative to each other and the rigid components to which they were attached. Typically, flexures with motion defining features machined in an assembly of parts after assembly will not be interchangeable as swapping positions of components would compound issues with the component, assembly, and alignment tolerances.

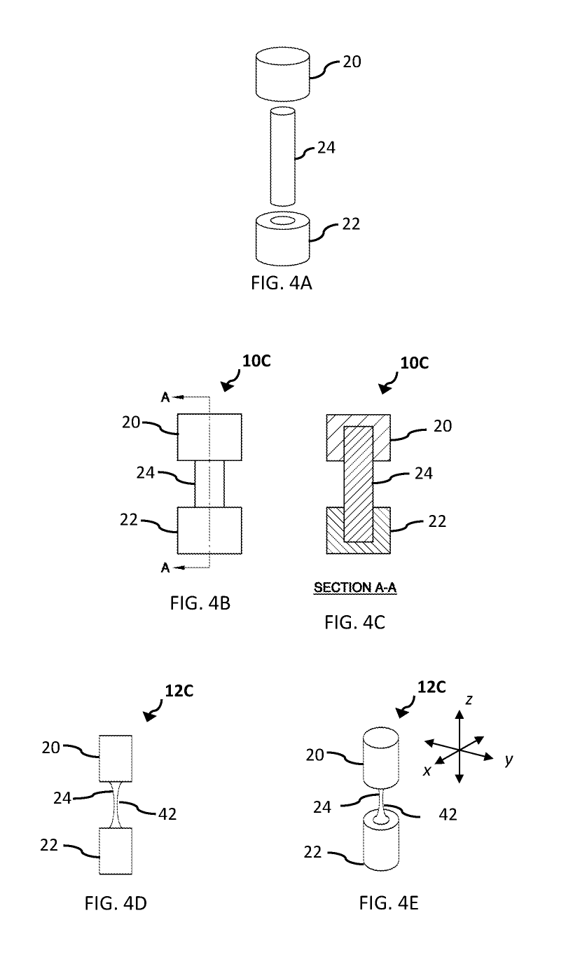

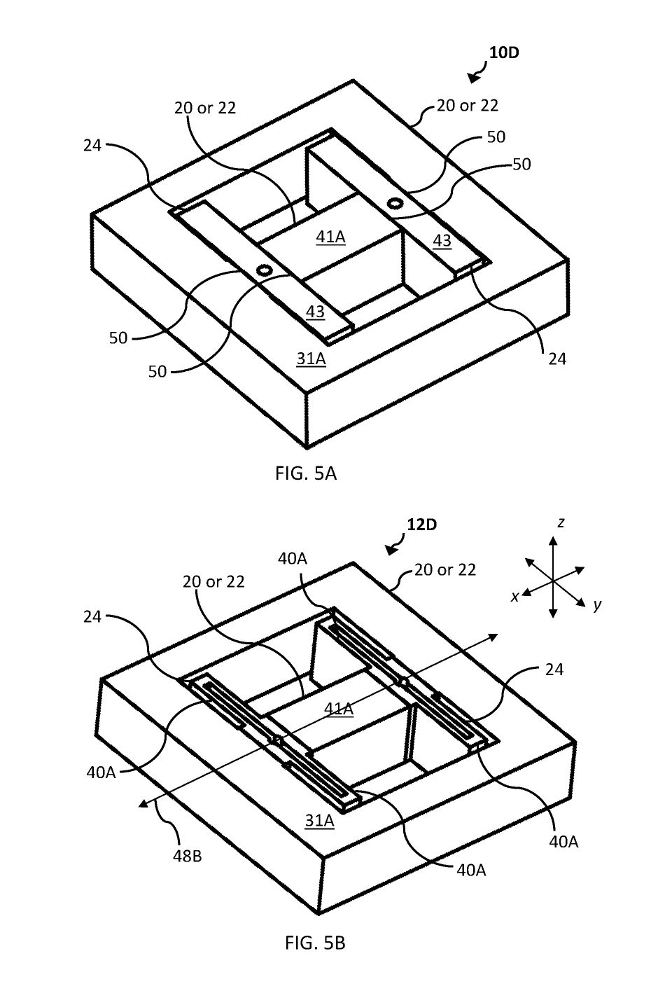

FIGS. 4A-4E illustrate the assembly of a first material 20, second material 22, and third material 24 being assembled into a flexure mechanism 12C. As in previous embodiments, first material 20 and second material 22 are non-flexure materials and third material 24 is a flexure material. FIGS. 4B and 4C illustrate the materials 20, 22, and 24 being joined together to form a monolithic-like structure 10C. In this embodiment, the materials 20, 22, and 24 may be fused, brazed, or welded together. In another embodiment, the materials 20, 22, and 24 may form an assembly of parts (not shown) by having third material 24 interference fit or press fit into first material 20 and second material 22.

FIGS. 4D and 4E illustrate a flexure-defining feature 42, in this case a spherical-notch flexure, that has been machined into the third material 24 after the materials 20, 22, and 24 have been joined. The resulting device is a flexure mechanism 12C that is configured to constrain motion of the first or second material to multiple radial vectors. FIG. 4E further illustrates with a Cartesian coordinate illustration the possible relative motion of material 20 with respect to material 22. In this embodiment, material 20 may move, relative to material 22, radially in the X-Z and Y-Z planes as well as allow some rotation about the Z axis. Additionally, in this embodiment, material 20 may not move, relative to material 22, transversely in the X, Y, or Z direction.

The order of operations of the assembly of monolithic-like structure 10C to flexure mechanism 12C is significant. In this embodiment, as in other embodiments, the flexure-motion defining feature 42 is formed or machined into the third material 24 after that material has been joined to first material 20 and second material 24. In this embodiment, the joining may have been performed through fusion, brazing, or welding processes that expose the materials 20, 22, and 24 to extreme heat. Had flexure-motion defining feature 42 been formed into third material 24 prior to the joining process, the relatively delicate flexure-motion defining feature 42 could have been damaged by the extreme heat of the forming process, reducing the life or performance of the flexure-motion defining feature 42 in flexure mechanism 12C.

FIG. 5A illustrates a monolithic-like, dual-opposing blade structure 10D that includes a base 31A, a carriage 41A, and flexure blocks 43A. The base 31A and carriage 41A are made from first or second material 20 or 22. The flexure blocks 43A are made from third material 24. As in other embodiments in the present disclosure, first or second materials 20 or 22 are non-flexure materials and third material 24 is a flexure material. Also, as in other embodiments in the present disclosure, first or second materials 20 or 22 may be the same material or different materials. The flexure blocks 43A are fused, brazed, or welded between the base 31A and carriage 41A at fused, brazed, or welded interfaces 50.

An exploded view of monolithic-like, dual-opposing blade structure 10D is not shown. However, each of the components of structure 10D, including the base 31A, carriage 41A, and flexure blocks 43 may be machined individually. The components may then be assembled in any order as an assembly of parts to form structure 10D. Significant tolerance stack-up may occur during the individual machining operations and assembly (either through fusing, brazing, or welding) of the individual components into structure 10D. However, these tolerance issues, miss-alignments or other flaws in the overall assembly may be eliminated in the forming of the flexure-motion defining features 42 as part of making the dual-opposing blade, fine-positioning linear stage 12D, illustrated in FIG. 5B and described below.

A dual-opposing blade, fine-positioning linear stage 12D includes blade flexures 40A that are formed between the base 31A and the carriage 41A. The combined blade flexures 40A constrain motion of the carriage 41A, relative to the base 31A, along a straight-motion line 48B that runs parallel to the X-axis, illustrated by the Cartesian arrows in FIG. 5B. The straightness of the straight-motion line 48B, and thus the quality or repeatability of the dual-opposing blade, fine-positioning linear stage 12D, depends upon how parallel the blade flexures 40A are relative to each other.

In embodiments, the blade flexures 40A are machined in a single machining operation. A “single machining operation” means manufacturing the blade flexures 40A (or other flexures or flexure-motion defining features 42, described throughout this disclosure) such that they are machined in a single manufacturing operation, i.e., the workpiece is not removed from the machine mount throughout the entire manufacturing operation. Machining the blade flexures 40A in a single machining operation allows the flexures to be as parallel as the tolerance limits of the machine forming the flexures. In some machines, like state-of-the-art wire or sinker electrical-discharge machines, the machine tolerance can be as low as twenty millionths of an inch over the entire build volume area of the machine. With these extremely tight tolerance manufacturing capabilities, forming the flexures in a single machining operation allows the blade flexures 40A (or other types of flexures described in other embodiments in this disclosure) to run substantially parallel, so as to reduce or eliminate tolerance stack-up, alignment error, and assembly and alignment steps and time. This, in turn, improves the performance and longevity of the dual-opposing blade, fine-positioning linear stage 12D. This performance is in contrast to the tolerance stack-up that can occur by adding pre-formed flexures individually to a flexure mechanism or machining multiple flexure-motion defining features in multiple operations, i.e., the workpiece is removed from the machine mount between individual flexure forming operations.

In addition to the benefits described above, in other embodiments, machining flexure-motion defining features 42 with a wire or sinker electrical-discharge machine minimizes localized deformation or residual stress in the flexure motion-defining feature 42. This also adds to the performance and longevity of the dual-opposing blade, fine-positioning linear stage 12D, or other motion stages described in this disclosure, because the resulting flexure-motion defining features 42 will not typically have forming induced material flaws or errors on the motion-defining features.

The order of operations of making dual-opposing blade, fine-positioning linear stage 12D from structure 10D is significant. In this embodiment, as in other embodiments, the blade flexures 40A are formed or machined into the third materials 24 after they have been joined to first or second materials 20 or 24. In addition to avoiding the extreme heat related issues described above with regards to flexure mechanism 12C, forming the blade flexures 40A after the third materials 24 have been joined to first or second materials 20 or 22 avoids assembly-of-parts tolerance and alignment issues.

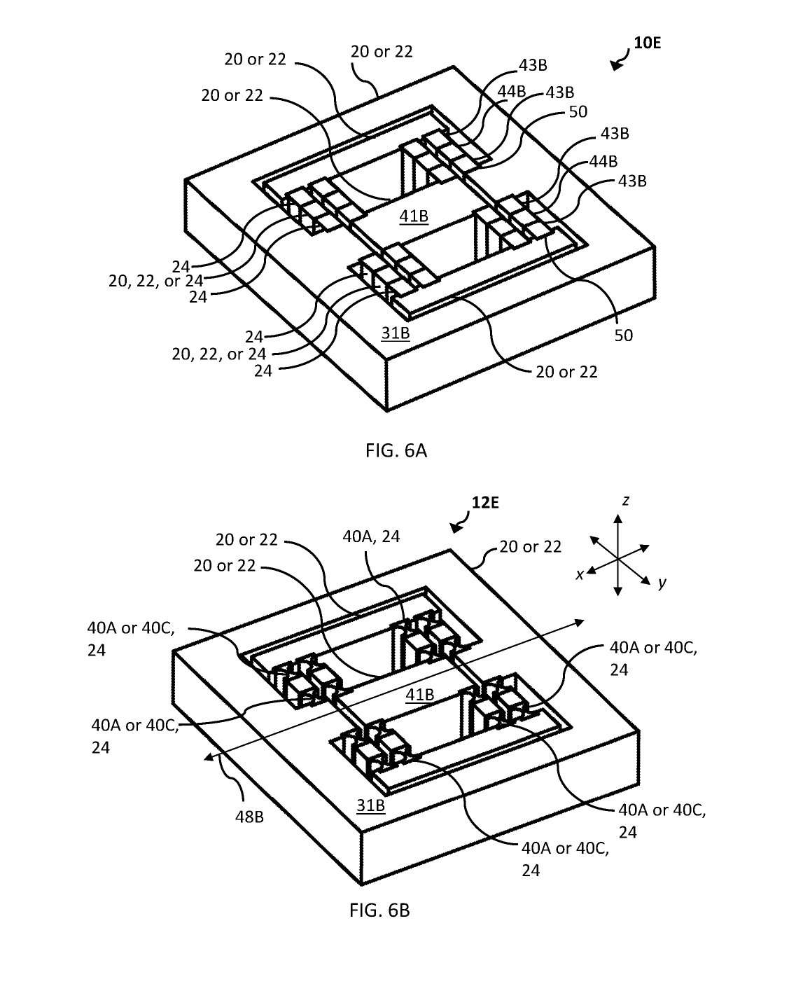

FIG. 6A illustrates a monolithic-like, block-blade structure 10E that includes a base 31B and a carriage 41B. The base 31B and carriage 41B are made from first or second material 20 or 22. Block-blade structure 10E also includes eight sets of flexure blocks 43B. For simplicity in FIG. 6A, only four flexure blocks 43B on one side of the block-blade structure 10E are labeled. The flexure blocks 43B are made from third material 24. As in other embodiments in the present disclosure, first or second materials 20 or 22 are non-flexure materials and third material 24 is a flexure material. Also, as in other embodiments in the present disclosure, first or second materials 20 or 22 may the same material or different materials.

FIG. 6A illustrates a non-flexure block 44B in between each set of flexure blocks 43B. For simplicity in manufacturing, or to reduce the number of fused, brazed, or welded interfaces, non-flexure block 44B may be made from first, second, or third material 20, 22, 24.

Additionally, the flexure blocks 43B and non-flexure blocks 44B are fused, brazed, or welded between the base 31B and carriage 41B at fused, brazed, or welded interfaces 50. Also for simplicity, only two fused, brazed, or welded interfaces 50 are shown in FIG. 6A. However, in this embodiment, wherever there is an interface between a first or second material 20 or 22, and a third material 24, there is a fused, brazed, or welded interface 50.

An exploded view of block-blade structure 10E is not shown. However, each of the components of structure 10E, including the base 31B, carriage 41B, non-flexure blocks 44B, and flexure blocks 43B may be machined individually. The components may then be assembled in any order as an assembly of parts to form structure 10E. Significant tolerance stack-up may occur during the individual machining operations and assembly (either through fusing, brazing, or welding) of the individual components into structure 10E. However, these tolerance issues, miss-alignments or other flaws in the overall assembly may be eliminated in the forming of the flexure-motion defining features 42 as part of making the block-blade, fine-positioning linear stage 12E, illustrated in FIG. 6B and described below.

A block-blade, fine-positioning linear stage 12E includes blade flexures 40A or planar notch flexures 40C that are formed between the base 31B and the carriage 41B. The combined blade flexures 40A or planar notch flexures 40C constrain motion of the carriage 41B, relative to the base 31B, along a straight-motion line 48B that runs parallel to the X-axis, illustrated by the Cartesian arrows in FIG. 6B. The straightness of the straight-motion line 48B, and thus the quality or repeatability of the block-blade, fine-positioning linear stage 12E, depends upon how parallel the blade flexures 40A, or planar notch flexures 40C, are relative to each other. In embodiments, the blade flexures 40A or planar notch flexures 40C are machined in a single machining operation.

The order of operations of making block-blade, fine-positioning linear stage 12E from structure 10E is significant. In this embodiment, as in other embodiments, the blade flexures 40A or planar notch flexures 40C are formed or machined into the third materials 24 after they have been joined to first or second materials 20 or 22. In addition to avoiding the extreme heat related issues described above with regards to flexure mechanism 12C, forming the blade flexures 40A or planar notch flexures 40C after the third materials 24 have been joined to first or second materials 20 or 22 avoids assembly-of-parts tolerance and alignment issues.

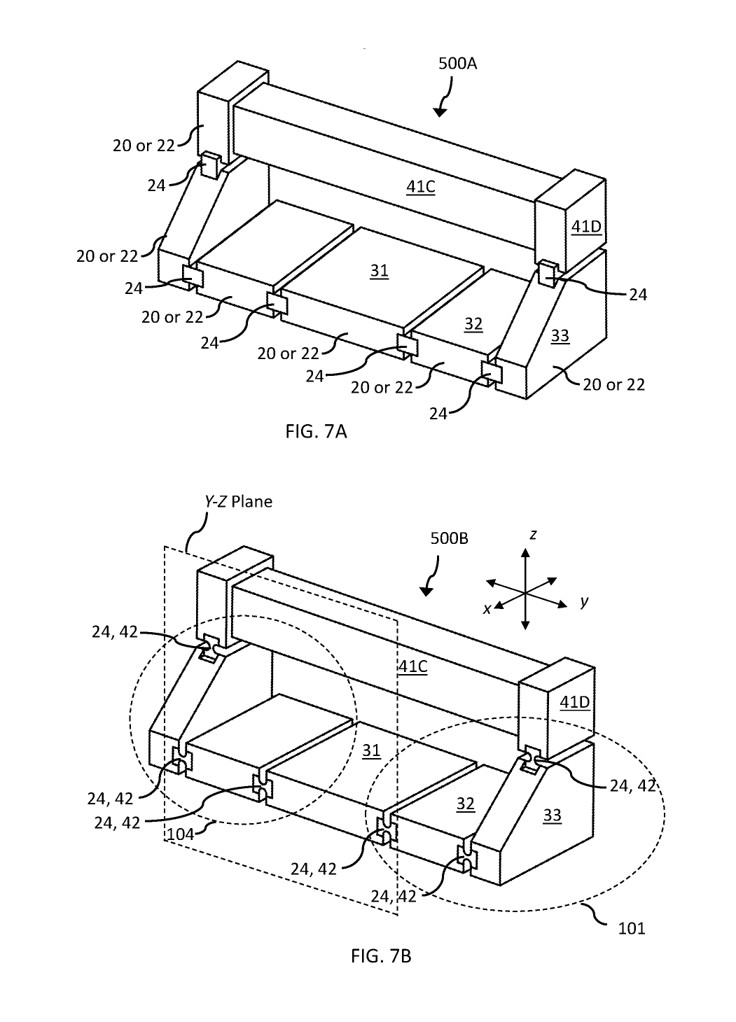

FIGS. 7A and 7B illustrate a monolithic-like structure 500A and planar motion stage 500B, respectively. Both monolithic-like structure 500A and planar motion stage 500B are similar to the linear-motion stage 500 illustrated in the Parent Disclosures, except that in this instant disclosure the monolithic-like structure 500A and the linear-motion stage 500B are made from materials 20, 22, and 24 and assembled with a very different manufacturing process.

Linear-motion stage 500 in the Parent Disclosures was machined monolithically and homogeneously from a single, flexure material, like titanium. In contrast, monolithic-like structure 500A includes first or second materials 20 or 22 and third materials 24. As in other embodiments in the present disclosure, first or second materials 20 or 22 are non-flexure materials and third material 24 is a flexure material. Thus, monolithic-like structure 500A is made up of both flexure and non-flexure materials such that monolithic-like structure 500A may be machined from aluminum for the base 31, first rigid element 32, second rigid element 33, carriage end 41D, carriage 41C, and so forth. Also, the components between the based 31, rigid elements 32 and 33, and carriage end 41D, are made from material 24, which is a flexure material.

An exploded view of monolithic-like structure 500A is not shown. However, each of the components of monolithic-like structure 500A, such as the base 31, rigid elements 32 and 33, the carriage and carriage end 41C and 41D, as well as each of the individual third material 24, may be machined individually. The components may then be assembled in any order as an assembly of parts to form monolithic-like structure 500A.

The flexure materials 24 and non-flexure materials 20 or 22 are joined through fusion, brazing, or welding processes. In another embodiment, the materials 20, 22, and 24 may be formed as an assembly of parts by having third materials 24 interference fit or press fit, glue bonded, or assembled by bolting into first or second materials 20 or 22.

Significant tolerance stack-up may occur during the individual machining operations and assembly (either through fusing, brazing, welding, press fitting, gluing, or bolt assembly) of the individual components into monolithic-like structure 500A. However, these tolerance issues, miss-alignments or other flaws in the overall assembly may be eliminated in the forming of the flexure-motion defining features 42 as part of making the planar-motion stage 500B, described below.

FIG. 7B illustrates planar motion stage 500B that has been machined from monolithic-like structure 500A. Planar motion stage 500B includes multiple-arm linkages 101 and 104, described in greater detail in the Parent Disclosures. Together, multiple-arm linkages 101 and 104 constrain motion of the carriage 41 and carriage end 41D to a plane, illustrated as the Y-Z plane in FIG. 7B. Multiple-arm linkages 101 and 104 also constrain motion of the carriage 41 and carriage end 41A to radial motion about the X-axis.

The order of operations of making flexure mechanism 500B from monolithic-like structure 500A is significant. In this embodiment, as in other embodiments, the flexure-motion defining features 42 are formed or machined into the third materials 24 after they have been joined to first or second materials 20 or 24. In addition to avoiding the extreme heat related issues described above with regards to flexure mechanism 12C, forming the flexure-motion defining features 42 after the third materials 24 have been joined to first or second materials 20 or 22 avoids assembly-of-parts tolerance and alignment issues, as describe below.

In embodiments, flexure-motion defining features 42 may be formed in third material 24 in a single machining operation. Also, FIG. 7B illustrates the flexure-motion defining features 42 as planar-notch flexures. Other flexures may be machined into the flexure mechanism 500B, such as beam flexures or cross flexures, or some combination of planar-notch flexures, beam flexures, and cross flexures. In particular, cross flexures may be formed as the flexure-motion defining features 42. Cross flexures have the distinct advantage of fully constraining motion to a single rotation vector. In contrast, spherical notch or beam flexures can be susceptible to multiple rotation vectors, asymmetric bending, or twisting.

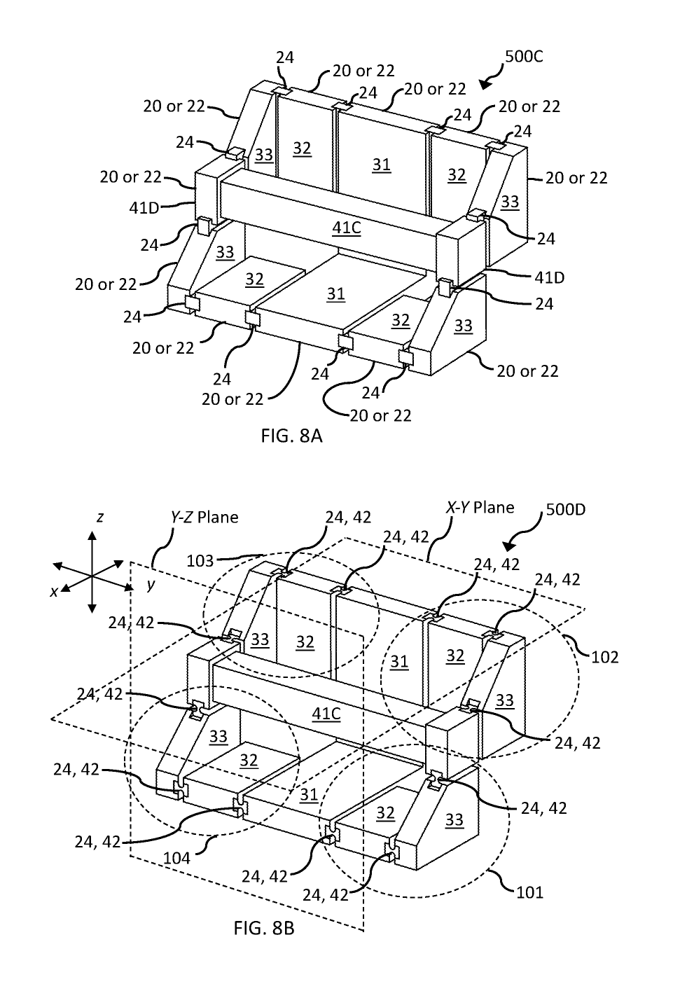

FIGS. 8A and 8B illustrate a monolithic-like structure 500C and linear-motion stage 500D, respectively. Both monolithic-like structure 500C and planar motion stage 500D are similar to the linear-motion stage 500 illustrated in the Parent Disclosures, except that in this instant disclosure the monolithic-like structure 500C and the linear-motion stage 500D are made from materials 20, 22, and 24 and assembled with a very different manufacturing process.

Monolithic-like structure 500C includes first or second materials 20 or 22 and third materials 24. As in other embodiments in the present disclosure, first or second materials 20 or 22 are non-flexure materials and third material 24 is a flexure material. Thus, monolithic-like structure 500C is made up of both flexure and non-flexure materials such that monolithic-like structure 500C may be machined from aluminum for the base 31, first rigid elements 32, second rigid elements 33, carriage ends 41D, carriage 41C, and so forth. Also, the components between the based 31, rigid elements 32 and 33, and carriage ends 41D, are made from material 24, which is a flexure material.

An exploded view of monolithic-like structure 500D is not shown. However, each of the components of monolithic-like structure 500D, such as the base 31, rigid elements 32 and 33, the carriage and carriage end 41D and 41C, as well as each of the individual third material 24, may be machined individually. The components may then be assembled in any order as an assembly of parts to form monolithic-like structure 500C.

The flexure materials 24 and non-flexure materials 20 or 22 are joined through fusion, brazing, or welding processes. In another embodiment, the materials 20, 22, and 24 may be formed as an assembly of parts by having third materials 24 interference fit or press fit, glue bonded, or assembled by bolting into first or second materials 20 or 22.

Significant tolerance stack-up may occur during the individual machining operations and assembly (either through fusing, brazing, welding, or press fitting) of the individual components into monolithic-like structure 500C. However, these tolerance issues, miss-alignments or other flaws in the overall assembly may be eliminated in the forming of the flexure-motion defining features 42 as part of making the planar-motion stage 500D, described below.

FIG. 8B illustrates planar motion stage 500D that has been machined from monolithic-like structure 500C. Planar motion stage 500D includes multiple-arm linkages 101, 102, 103, and 104, described in greater detail in the Parent Disclosures. Together, multiple-arm linkages 101 and 104 constrain motion of the carriage 41C and carriage end 41C to a plane, illustrated as the Y-Z plane in FIG. 8B. Additionally, multiple-arm linkages 102 and 103 constrain motion of the Multiple-arm linkages 101 and 104 also constrain motion of the carriage 41C and carriage end 41C to a plane, illustrated as the X-Y plane. Together, multiple arm linkages 101, 102, 103, and 104 constrain motion of the carriage 41C and carriage end 41C to a line, as described in more detail in the Parent Disclosures.

For linear-motion stage 500D, the flexure-motion defining features 42 are formed or machined into the third materials 24 after they have been joined to first or second materials 20 or 24. In addition, the flexure-motion defining features 42 may be formed in a single machining operation. Also, FIG. 8B illustrates the flexure-motion defining features 42 as planar-notch flexures. Other flexures may be machined into the flexure mechanism 500D, such as beam flexures or cross flexures, or some combination of planar-notch flexures, beam flexures, and cross flexures. In particular, cross flexures may be formed as the flexure-motion defining features 42. Cross flexures have the distinct advantage of fully constraining motion to a single rotation vector. In contrast, spherical notch or beam flexures can be susceptible to multiple rotation vectors, asymmetric bending, or twisting.

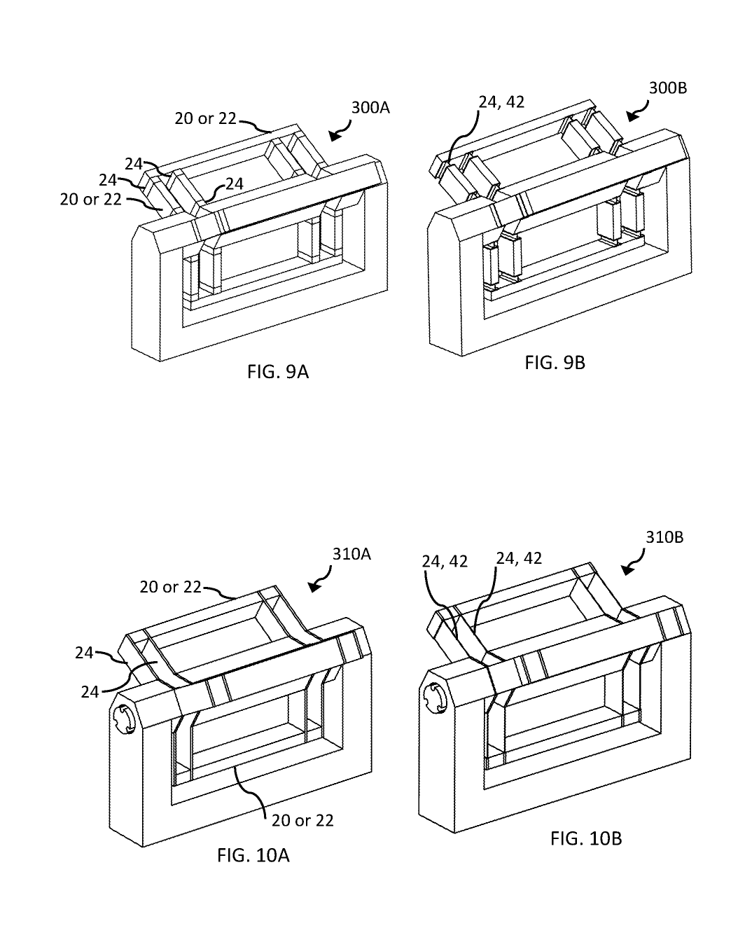

FIG. 9A illustrates a monolithic-like structure 300A and FIG. 9B illustrates an angularly and radially symmetrical three-arm linear-motion stage 300B with block-blade flexures. Both monolithic-like structure 300A and radially symmetrical three-arm linear-motion stage 300B are similar to the radially symmetrical three-arm linear-motion stage 300 illustrated in the Parent Disclosures except that in this instant disclosure the monolithic-like structure 300A and the angularly and radially symmetrical three-arm linear-motion stage 300B with block-blade flexures are made from materials 20, 22, and 24 and are assembled with a different manufacturing process.

Monolithic-like structure 300A and radially symmetrical three-arm linear-motion stage 300B include first or second materials 20 or 22 and third materials 24. In FIG. 9A, only two of the components that comprise first or second materials 20 or 22 and only three of the components that comprise third material 24 are labeled. Similarly, in FIG. 9B, only one of the flexures 42 is labeled. However, all of the flexures illustrated in FIG. 9B are made from third material 24. Additionally, the non-flexure parts of radially symmetrical three-arm linear-motion stage 300B may be made from any of first, second, or third material 20, 22, or 24, depending on what is easiest to manufacture as an assembly of parts.

Each of the components of monolithic-like structure 300A, including those components made from any of first, second, or third material 20, 22, or 24, may be machined individually. The components may then be assembled in any order as an assembly of parts to form monolithic-like structure 300A. For monolithic-like structure 300A, the flexure materials 24 and non-flexure materials 20 or 22 are joined through fusion, brazing, or welding processes.

Significant tolerance stack-up may occur during the individual machining operations and assembly (either through fusing, brazing, welding, or press fitting) of the individual components into monolithic-like structure 300A. However, these tolerance issues, miss-alignments or other flaws in the overall assembly may be eliminated in the forming of the flexure-motion defining features 42 as part of making the radially symmetrical three-arm linear-motion stage 300B, described below.

FIG. 9B illustrates angularly and radially symmetrical three-arm linear-motion stage 300B with block-blade flexures that has been machined from monolithic-like structure 300A. The linkage sets (not labeled in the instant disclosure) in the radially symmetrical three-arm linear-motion stage 300B constrain motion of the carriage (also not labeled here) as shown and described in the Parent Disclosures.

FIG. 10A illustrates a monolithic-like structure 310A and FIG. 10B illustrates an angularly and radially symmetrical three-arm linear-motion stage 310B with blade flexures. Both monolithic-like structure 310A and radially symmetrical three-arm linear-motion stage 310B are similar to the radially symmetrical three-arm linear-motion stage 310 illustrated in the Parent Disclosures except that in this instant disclosure the monolithic-like structure 310A and the angularly and radially symmetrical three-arm linear-motion stage 310B with blade flexures are made from materials 20, 22, and 24 and assembled with a very different manufacturing process.

Monolithic-like structure 310A and radially symmetrical three-arm linear-motion stage 310B include first or second materials 20 or 22 and third materials 24. In FIG. 10A, only two of the components that comprise first or second materials 20 or 22 and only two of the components that comprise third material 24 is labeled. Similarly, in FIG. 9B, only two of the flexures 42 is labeled. However, all of the flexures illustrated in FIG. 9B are made from third material 24. Additionally, the non-flexure parts of radially symmetrical three-arm linear-motion stage 310B may be made from any of first, second, or third material 20, 22, or 24, depending on what is easiest to manufacture as an assembly of parts.

Each of the components of monolithic-like structure 310A, including those components made from any of first, second, or third material 20, 22, or 24, may be machined individually. The components may then be assembled in any order as an assembly of parts to form monolithic-like structure 310A. For monolithic-like structure 310A, the flexure materials 24 and non-flexure materials 20 or 22 are joined through fusion, brazing, or welding processes.

Significant tolerance stack-up may occur during the individual machining operations and assembly (either through fusing, brazing, welding, or press fitting) of the individual components into monolithic-like structure 310A. However, these tolerance issues, miss-alignments or other flaws in the overall assembly may be eliminated in the forming of the flexure-motion defining features 42 as part of making the radially symmetrical three-arm linear-motion stage 300B, described below.

FIG. 10B illustrates an angularly and radially symmetrical three-arm linear-motion stage 310B, with blade flexures, that has been machined from monolithic-like structure 310A. Comparing FIGS. 10A and 10B, it can be difficult to see the difference between the third materials 24 (shown in FIG. 10A) that become the flexure-motion defining features 42 (shown in FIG. 10B). This is because the original third-materials 24 in monolithic-like structure 310A need not be very thick, only thick enough to join to first or second materials 20 or 22 in monolithic-like structure 310A without damaging the third-materials 24 in monolithic-like structure 310A. The original third-materials 24 in monolithic-like structure 310A, however, are not so thin as to be flexure-motion defining features 42 (shown in FIG. 310B). The flexure-motion defining features 42 are machined from the thicker, original third-materials 24 in monolithic-like structure 310A.

The machining of the flexure-motion defining features 42 from the thicker, original third-materials 24 eliminates the tolerance stack-up that may have occurred during the machining operations of the individual components and assembly (either through fusing, brazing, welding, or press fitting) of the individual components into monolithic-like structure 310A. The elimination of the tolerance stack-up through the machining operation produces a radially symmetrical three-arm linear-motion stage 310B with linkage sets (not labeled in the instant disclosure) that constrain motion of the carriage (also not labeled here) to a line, as described in the Parent Disclosures.

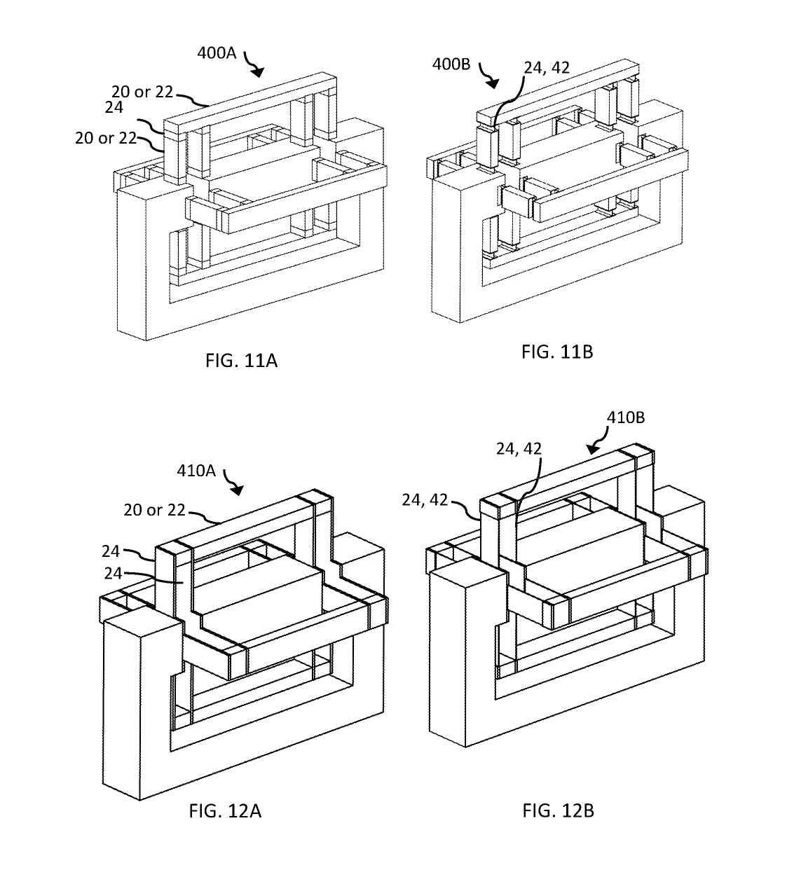

FIG. 11A illustrates a monolithic-like structure 400A and FIG. 11B illustrates an angularly and radially symmetrical four-arm linear-motion stage 400B with block-blade flexures. Both monolithic-like structure 400A and radially symmetrical four-arm linear-motion stage 400B are similar to the radially symmetrical three-arm linear-motion stage 400 illustrated in the Parent Disclosures. Additionally, monolithic-like structure 400A and four-arm linear-motion stage 400B comprise the same materials and are assembled in the same manner as monolithic-like structure 300A (shown in FIG. 9A) and radially symmetrical three-arm linear-motion stage 300B with block-blade flexures (shown in FIG. 9B), both described above.

FIG. 12A illustrates a monolithic-like structure 410A and FIG. 12B illustrates an angularly and radially symmetrical four-arm linear-motion stage 400B with blade flexures. Both monolithic-like structure 410A and radially symmetrical four-arm linear-motion stage 410B are similar to the radially symmetrical three-arm linear-motion stage 400 illustrated in the Parent Disclosures except that in this instant disclosure the monolithic-like structure 410A and the radially symmetrical four-arm linear-motion stage 410B are made from materials 20, 22, and 24 and assembled with a very different manufacturing process.

Monolithic-like structure 410A and four-arm linear-motion stage 410B comprise the same materials and are assembled in the same manner as monolithic-like structure 310A (shown in FIG. 10A) and radially symmetrical three-arm linear-motion stage 310B with blade flexures (shown in FIG. 10B), both described above.

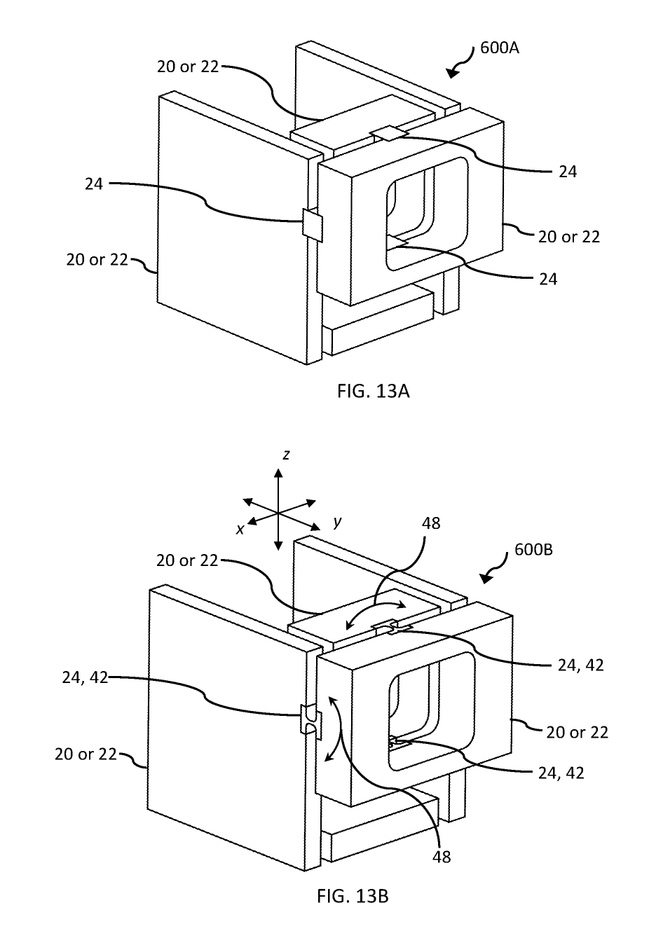

FIGS. 13A and 13B illustrate a monolithic-like structure 600A and a two-axis optical mount 600B with two sets of flexures. Both monolithic-like structure 600A and two-axis optical mount 600B are similar to the two-axis optical mount illustrated in U.S. Pat. No. 8,542,450, issued Sep. 24, 2013 and U.S. Pat. No. 8,792,192, issued Jul. 29, 2014, both entitled “Kinematic Optic Mount” (and incorporated herein by reference in their entirety), except that in this instant disclosure, the monolithic-like structure 600A and the two-axis optical mount 600B are made from materials 20, 22, and 24 and assembled with a very different manufacturing process.

The kinematic optic mount in the above-referenced patents is monolithically and homogeneously formed from a single, flexure-like material. In contrast, monolithic-like structure 600A and a two-axis optical mount 600B is made from non-flexure first and second materials 20 or 22 and flexure-like third material 24.

In addition, monolithic-like structure 600A and a two-axis optical mount 600B is assembled with a very different manufacturing process. In embodiments, components comprising the monolithic-like structure 600A may be machined as separate pieces and then combined fusion, brazing, or welding processes. When combined, third material 24 would not have a flexure-motion defining feature 42 that could be damaged by the extreme heat of the forming process, reducing the life or performance of the flexure-motion defining feature 42 in the two-axis optical mount 600B.

Additionally, significant tolerance stack-up may occur during the individual machining operations and assembly (either through fusing, brazing, or welding) of the individual components into monolithic-like structure 600A. This tolerance stack-up would have introduced joint-type accuracy errors in the flexures of the two-axis optical mount of the referenced patents. These errors would make the two-axis optical mount unsuitable for its intended precision optical alignment function.

However, these tolerance issues, miss-alignments or other flaws in the overall assembly may be eliminated in the forming of the flexure-motion defining features 42 as part of making the two-axis optical mount 600B. This is because the flexure-motion defining features 42 are formed after the joining step. In embodiments, forming the flexure defining features 42 comprises forming two or more flexures that together are configured to constrain motion of the first or second material to a radial vector. FIG. 13B illustrates these radial vectors as movement indicators 48.

In other embodiments, forming the flexure-motion defining features 42 may be performed in a single machining operation. When completely manufactured, two-axis optical mount 600B may have the same precision alignment features as if it were monolithically and homogeneously formed from a single, flexure-like material.

In FIG. 13A, as in other Figures and embodiments, monolithic-like structure 600B includes third-material 24 that is in the form of a square or rectangular block. This geometric form prevents rotational movement of the first material relative to the second material.

Additionally, FIG. 13B illustrates two-axis optical mount 600B as having flexure-motion defining features 42 in the form of a spherical-notch flexure. In other embodiments, two-axis optical mount 600B may have flexure-motion defining features 42 that are beam flexures, cross flexures, or planar notch flexures. In particular, cross flexures may be formed as the flexure-motion defining features 42. Cross flexures have the distinct advantage of fully constraining motion to a single rotation vector, shown with the movement indicators 48 in FIG. 13B. In contrast, spherical notch or beam flexures can be susceptible to multiple rotation vectors, asymmetric bending, or twisting.

It will be appreciated that several of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

The present invention may be embodied in other specific forms without departing from its spirit or essential characteristics. The described embodiments are to be considered in all respects only as illustrative, and not restrictive. All changes which come within the meaning and range of equivalency of the foregoing description are to be embraced within the scope of the invention.

What is claimed is:

1. A method comprising:
joining a first, second, and third material together, wherein the first and second materials are non-flexure materials and the third material is a flexure material that does not have a flexure-motion defining feature; and then after the joining step,
forming a flexure-motion defining feature into the third material.

2. The method of claim 1, wherein the forming the flexure-motion defining feature comprises forming a flexure that is configured to constrain motion of the first material relative to the second material to multiple radial vectors.

3. The method of claim 1, wherein the forming the flexure-motion defining feature comprises forming two or more flexures that together are configured to constrain motion of the first material, relative to the second material, to a single plane.

4. The method of claim 3, wherein the forming the two or more flexures is done in a single machining operation.

5. The method of claim 1, wherein the forming the flexure-motion defining feature comprises forming two or more flexures that together are configured to constrain motion of the first material, relative to the second material, along a straight-line vector.

6. The method of claim 5, wherein the forming the two or more flexures is done in a single machining operation.

7. The method of claim 1, wherein the forming the flexure-motion defining feature comprises forming two or more flexures that together are configured to constrain motion of the first material relative to the second material to a radial vector.

8. The method of claim 7, wherein the forming the two or more flexures is done in a single machining operation.

9. The method of claim 1, wherein the forming the flexure-motion defining feature comprises forming a cross flexure that is configured to constrain motion of the first material radially, relative to the second material.

10. The method of claim 1, wherein the joining step comprises joining the third material to the first and second materials such that all joints between the first and third materials or the second and third materials are removed.

11. The method of claim 1, wherein the joining step comprises bolting each of the first and second materials to the third material.

12. The method of claim 1, wherein the joining step comprises glueing each of the first and second materials to the third material.

13. The method of claim 1, wherein prior to the forming step, the third material is in a geometric form which prevents rotational movement of the first material relative to the second material or the first material relative to the third material.

14. The method of claim 1, wherein the forming the flexure-motion defining feature comprises a forming method that minimizes localized deformation or residual stress into the flexure-motion defining feature.

15. The method of claim 1, wherein the forming the flexure-motion defining feature comprises forming the flexure-motion defining feature by selectively removing material from the third material.

16. A method comprising:
providing a monolithic-like structure comprising a first, second, and third material, wherein the first and second materials are non-flexure materials and the third material is a flexure material that does not have a flexure motion-defining feature; and then after the providing step,
forming a flexure-motion defining feature into the third material.
